(19) United States
(12) Patent Application Publication
(10) Pub. No.: US 2009/0034821 A1
(43) Pub. Date: Feb. 5, 2009

(54) RADIATION IMAGE PROCESSING DEVICE

(75) Inventors: Hiroshi Onihashi, Nasushiobara-shi (JP); Junsuke Koma, Otawara-shi (JP); Hiroshi Iwata, Yokohama-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); Toshiba Electron Tubes & Devices Co., Ltd., Otawara-shi (JP)

(21) Appl. No.: 12/183,436

(22) Filed: Jul. 31, 2008

(30) Foreign Application Priority Data
Aug. 3, 2007 (JP) 2007-202677

(51) Int. Cl. G06K 9/00

(52) U.S. Cl. 382/132

(57) ABSTRACT

A radiation image processing device comprises a noise component extraction part which extracts a noise component from a radiation image, a line-shaped noise component extraction part which extracts a line-shaped noise component from the noise component extracted by the noise component extraction part, and a line-shaped noise component subtraction part which subtracts the line-shaped noise component, extracted by the line-shaped noise component extraction part, from the radiation image.

### CROSS-REFERENCE TO RELATED APPLICATIONS

This application is based upon and claims the benefit of priority from prior Japanese Patent Application No. 2007-202677, filed Aug. 3, 2007, the entire contents of which are incorporated herein by reference.

### BACKGROUND OF THE INVENTION

1. Field of the Invention

The present invention relates to a radiation image processing device which removes only a line-shaped noise component of a radiation image.

2. Description of the Related Art

In an X-ray image processing device, it is important to separate an image signal component and a noise component from an X-ray image signal containing noise, as disclosed in Jpn. Pat. Appln. KOKAI Publication No. 2004-187744 (p. 2), for example.

In the X-ray image signal, X-ray quantum noise and noise generated within an X-ray flat panel detector cause a problem. For example, there are various types of noise generated within a TFT type X-ray flat panel detector. Especially, a noise component generated in substantially the same phase in the gate scanning has a line shape and is generated like pounding of beats, and therefore, this noise component is much more noticeable than a noise component randomly generated in each pixel.

The noise generated in a line shape possesses a characteristic that the beat is easily pounded when noise near harmonic which is n times of gate scanning frequency is generated. According to simulation, if the noise generated in a line shape is more than about 1/7 of the random noise, the noise generated in a line shape becomes noticeable on a screen. The noise generated in a line shape is more concerned than other noise generated in the X-ray image processing device. Thus, the removal of the noise generated in a line shape and the like is expected to offer a great effect.

The line-shaped noise is also generated randomly. When the time average is taken, the average value gradually comes closer to 0. As with the random noise, the line-shaped noise is not determinately generated, unlike the noise generated in a fixed pattern, and the line-shaped noise is not completely removed from the X-ray image signal.

In a simple smoothing filter, information of an object contour region containing a high-frequency component is deleted with the removal of the noise component. Therefore, an edge preserving smoothing filter such as a median filter, which possesses a characteristic free from the smoothing of the object contour region, has also been developed.

However, in the conventional noise removal technique using a smoothing filter, fine image components may be removed. Further, an X-ray image in the amount of see-through lines is a random noise component by X-ray quantum noise, and therefore, the S/N ratio of the image is low. According to this constitution, even if the amplitude of image information is large to some extent, it is difficult to remove only the line-shaped noise component.

The conventional noise removal technique using the smoothing filter is used for removing easily-noticeable high-frequency noise through a low-frequency filter. Therefore, there is a problem that image resolution is degraded due to the removal of the high-frequency noise.

### BRIEF SUMMARY OF THE INVENTION

The present invention has been made in view of the above problems, and it is an object thereof to provide a radiation image processing device which can effectively remove only line-shaped noise without affecting a radiation image.

To achieve the object, according to an aspect of the present invention, there is provided a radiation image processing device comprising:

a noise component extraction part which extracts a noise component from a radiation image;

a line-shaped noise component extraction part which extracts a line-shaped noise component from the noise component extracted by the noise component extraction part; and

a line-shaped noise component subtraction part which subtracts the line-shaped noise component, extracted by the line-shaped noise component extraction part, from the radiation image.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a radiation image processing device showing an embodiment of the invention;

FIG. 2 is a block diagram showing the detail of the radiation image processing device;

FIG. 3 is an explanatory view showing a noise component extraction determinant in the radiation image processing device;

FIG. 4 is an explanatory view of a block, in which noise is extracted, in the radiation image processing device; and

FIG. 5 is a graph showing a histogram obtained in the unit of block in the radiation image processing device.

### DETAILED DESCRIPTION OF THE INVENTION

Hereinafter, an embodiment of the invention will be described with reference to the drawings.

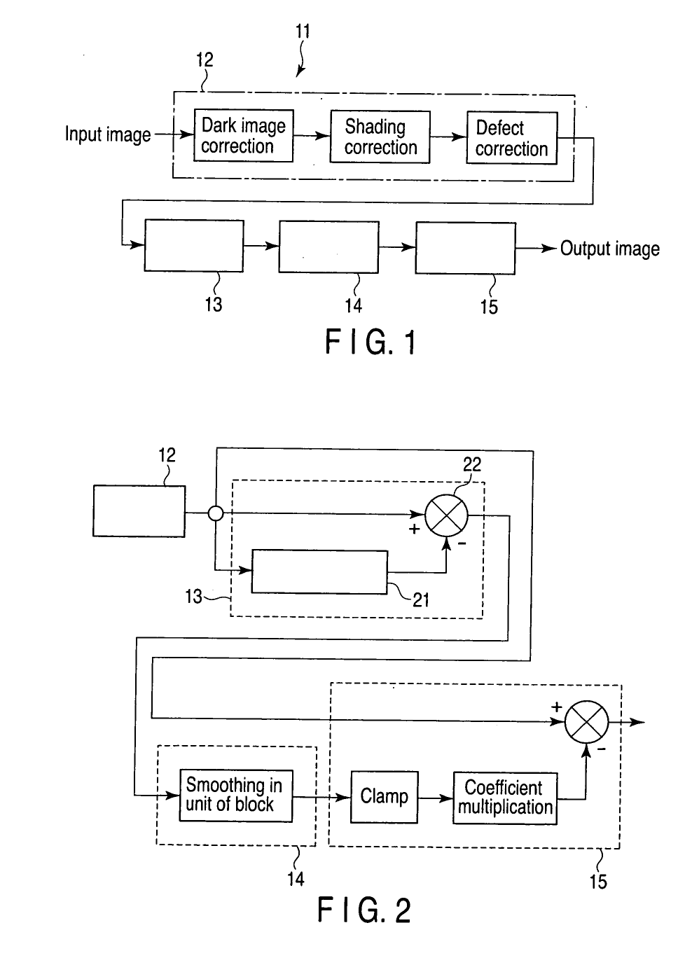

FIG. 1 is a block diagram showing a radiation image processing device. As shown in FIGS. 1 and 2, a radiation image processing device 11 includes a image correction block 12, a noise component extraction block 13 as a noise component extraction part, a line-shaped noise component extraction block 14 as a line-shaped noise component extraction part, and a line-shaped noise component subtraction block 15 as a line-shaped noise component subtraction part.

In the image correction block 12, the brightness of an input image as an X-ray image is corrected. The X-ray image is a radiation image detected by an X-ray flat panel detector, which is a radiation flat panel detector, for example. In the noise component extraction block 13, a noise component is extracted from the input image subjected to the image correction. In the line-shaped noise component extraction block 14, only a line-shaped noise component is extracted from the noise component extracted in the noise component extraction block 13. In the line-shaped noise component subtraction block 15, the extracted line-shaped noise component is subtracted from the input image subjected to the image correction.

Accordingly, an output image from which the line-shaped noise component has been removed can be obtained through the image correction block 12, the noise component extraction block 13, the line-shaped noise component extraction block 14, and the line-shaped noise component subtraction block 15.

The input image is first passed through the image correction block 12, whereby the line-shaped noise is effectively removed. In the image correction block 12, offset correction, gain correction, and defect correction are applied to the input image. In the offset correction, an offset image is removed in order to remove the offset of the image generated due to, for example, leakage current in a circuit. In the gain correction, variation in the gain of each pixel is corrected. In the defect correction, a defect pixel is corrected. Incidentally, if there is no offset in darkness, variation in each pixel, or defect pixel, these processings are not required.

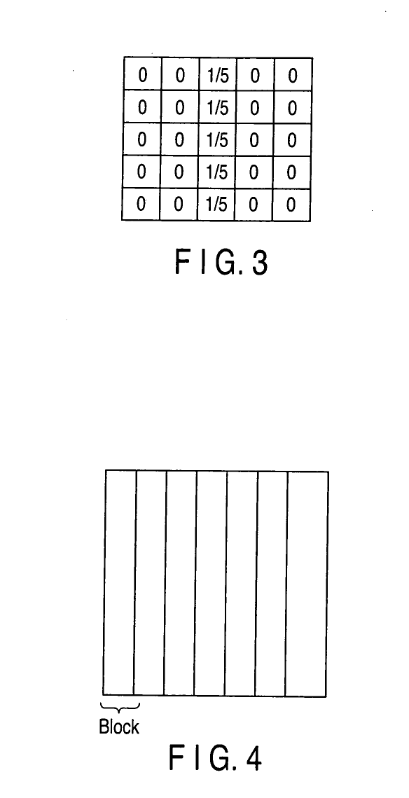

In the noise component extraction block 13, a smoothing filter 21 as a smoothing part is applied to each pixel of the input image. The smoothing filter 21, as shown, for example, in FIG. 3, calculates the summation of a certain reference pixel in the input image and the adjacent pixels by using n×n matrix operation to replace the summation with the reference pixel. The smoothing filter 21 performs the above processings with respect to all pixels.

The size of the matrix is related to the size of the period of line-shaped noise being generated. When only a high-frequency noise component is removed, the matrix size may be reduced, while, when a noise component of a relatively low frequency is removed in addition to the high-frequency noise component, the matrix size may be increased. In the example shown in FIG. 3, although the matrix size is 5×5, there is a coefficient with respect to an axis perpendicular to the direction where the line-shaped noise is generated (it is assumed that the line-shaped noise is generated in the lateral axis direction), and all other matrix terms are 0.

As the smoothing filter 21, there is a one-dimensional smoothing filter having a coefficient only with respect to an axis perpendicular to the line where the line-shaped noise is generated. When the one-dimensional smoothing filter is used, the calculation is performed only with respect to the axis direction where the line-shaped noise is generated, and therefore, the image information in the lateral direction is not contained. In this example, although the coefficient is assumed to be ⅕, the coefficient may be weighted. Further, as the smoothing filter 21, there is a one-dimensional median filter. The one-dimensional median filter has an advantage that the information about a local noise variation is less likely to be contained.

Further, the noise component extraction block 13 includes a smoothing component subtraction part 22. The smoothing component subtraction part 22 subtracts the pixel value of the image, which has been passed through the smoothing filter 21, from the pixel value of each pixel of the input image. According to this constitution, in the noise component extraction block 13, it is possible to obtain a noise component image in which image information is not included in the direction where the line-shaped noise is generated.

In the line-shaped noise component extraction block 14, as shown in, for example, FIG. 4, the noise component image extracted in the noise component extraction block 13 is divided into a plurality of blocks in the direction where the line-shaped noise is generated (it is assumed that the line-shaped noise is generated in the lateral axis direction), calculates, with respect to the noise component image extracted in the noise component extraction block 13, the average value of the noise components on the same line in the unit of block, and calculates the noise components generated in the same phase within the same block. In the line-shaped noise component extraction block 14, the average value and the pixel value of the noise component image are replaced with each other in the unit of block, whereby a random noise component is removed, and only the line-shaped noise component can be extracted.

When the averaging number within a block is represented as n, and when, regarding the line-shaped noise component, the standard deviation of the random noise components generated on the same line is represented as σr, the statistical error generated by this averaging processing is σr/\sqrt{n}. Thus, if n is small, the random noise is superimposed, and therefore, the selection of n requires attention. Meanwhile, if the smoothing processing is performed in the noise component extraction block 13, edge information is also subjected to the smoothing processing in an image with strong contrast, and therefore, a pseudo image is easily generated. In order to reduce the influence of the image edge, it is preferable that n≧16.

As means for reducing the influence of the image edge, extracted in the noise component extraction block 13, in the extraction of the line-shaped noise component, there is a median filter. The median filter possesses a characteristic less likely to be affected by the image edge, and therefore, the line-shaped noise component can be effectively extracted. The median filter replaces, with respect to the noise component extracted in the noise component extraction block 13, the pixel value of the noise component, which is a median on the same line in the unit of block, with a reference pixel.

However, even when the median filter is used, with respect to the image in which contrast is polarized between white and black, a value near the histogram median is largely changed. Thus, the image in which contrast is polarized is not satisfactorily corrected.

Therefore, instead of using a median, the pixel values of the noise components on the same line which have been extracted in the noise component extraction block 13 are arranged in the ascending/descending order, and the pixel value in a certain order is replaced with the pixel value within the same block, whereby the error in the median occurring in the median filter can be prevented.

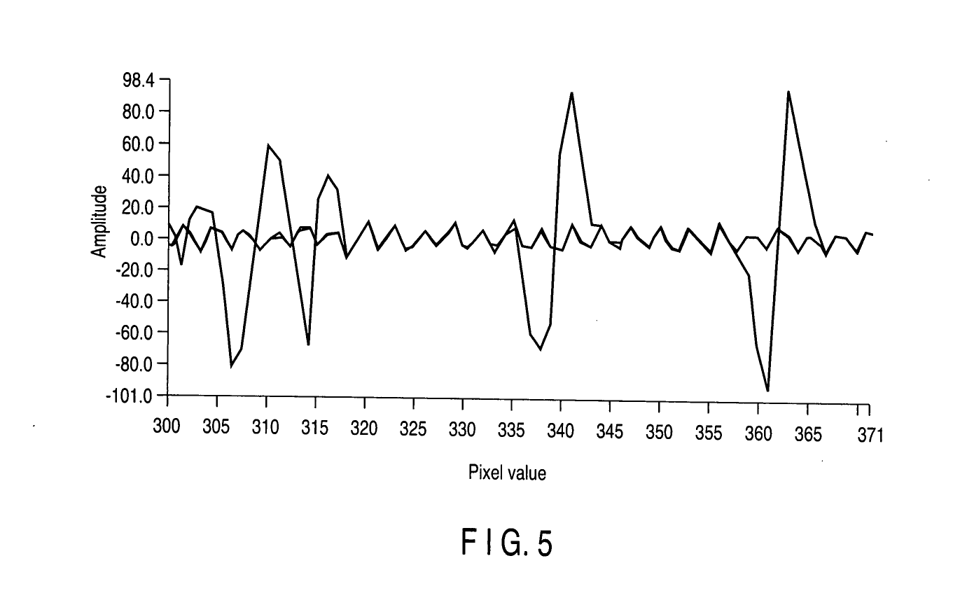

Further, the pixel values of the noise components on the same line are arranged in the ascending/descending order in the unit of block, and a plurality of reference pixel values in a certain order are obtained. With respect to the respective pixel values in a certain order, an image in which the pixel value within the same block is replaced with the pixel value in that order is obtained. The pixel value exceeding a certain threshold value is eliminated, and the average value of the pixel values is calculated, whereby the error in a median occurring in a median filter can be prevented, and only the line-shaped noise component can be efficiently detected. For example, FIG. 5 is a graph in which the histogram is calculated in the unit of block, and the pixel value of top 10%, the median value, and the pixel value of bottom 10% are calculated with respect to the axis perpendicular to the axis where the line-shaped noise is generated. When the median of the histogram comes close to the value of the reference pixel, the pixel value is largely changed, and therefore, the correction error occurs. A largely changed part of the graph in FIG. 5 shows the occurrence of the correction error. When a target pixel value, which is set to be the pixel value of top 10%, the median value, or the pixel value of bottom 10%, exceeds a certain threshold value, the pixel value is removed, and other pixel values are averaged, whereby the error occurring in the median filter can be prevented, and the line-shaped noise component can be efficiently corrected.

Further, as shown in FIG. 2, in the line-shaped noise component subtraction block 15, when the line-shaped noise component is satisfactorily smaller than the random noise component (not more than 1/7), in order to reduce the influence of the pseudo image generated by the correction, the image of the line-shaped noise component extracted in the line-shaped noise component extraction block 14 is clamped, and a certain coefficient is multiplied by the image of the line-shaped noise component and then subtracted from the input image, whereby the correction effect is restricted.

When the entire histogram is largely changed in the unit of block, an image becomes unnatural due to the correction. Therefore, when the pixel value of the line-shaped noise component image extracted in the line-shaped noise component extraction block 14 exceeds a certain threshold value, the pixel value is replaced with a certain threshold value, and thus the noise component is prevented from being further subtracted, whereby only the line-shaped noise component can be effectively removed without losing the object contour information of the input image.

As above, in the radiation image processing device 11, the noise component is extracted from the input image in the noise component extraction block 13, only the line-shaped noise component is extracted from the noise component, extracted in the noise component extraction block 13, in the line-shaped noise component extraction block 14, and the line-shaped noise component, extracted in the line-shaped noise component extraction block 14, is subtracted from the input image in the line-shaped noise component subtraction block 15. Therefore, only the line-shaped noise component can be effectively removed without affecting the input image.

Further, in the noise component extraction block 13 in which the noise component is extracted, the smoothing filter 21 is applied to each pixel of the input image, and the pixel value of the image smoothed by the smoothing filter 21 is subtracted from the pixel value of each pixel of the input image, whereby the noise component can be extracted.

As the smoothing filter 21, a one-dimensional smoothing filter is applied with respect to the axis perpendicular to the axis where the line-shaped noise is generated, whereby it is possible to obtain the noise component image not including the image information in the direction where the line-shaped noise is generated, and thus the line-shaped noise can be effectively extracted. In addition, as the smoothing filter 21, a one-dimensional median filter is applied with respect to the axis perpendicular to the axis where the line-shaped noise is generated, whereby the noise component image, which does not include the image information in the direction where the line-shaped noise is generated, is obtained without smoothing the object contour information, whereby the line-shaped noise can be effectively extracted.

In the line-shaped noise component extraction block 14 in which the noise component generated in a line shape is extracted, with respect to the noise components extracted in the noise component extraction block 13, the average value of the noise components on the same line is calculated in the unit of block, and the average value is subtracted from the noise components within the same block, whereby even if there is fluctuation in the noise generated in a line shape, only the line-shaped noise can be effectively extracted.

Further, in the line-shaped noise component extraction block 14 in which the noise component generated in a line shape is extracted, with respect to the noise components extracted in the noise component extraction block 13, the median of the pixels of the noise components on the same line is obtained in the unit of block, and the median is subtracted from the noise component within the same block, whereby only the line-shaped noise can be effectively extracted without smoothing the object contour information.

Further, in the line-shaped noise component extraction block 14 in which the noise component generated in a line shape is extracted, with respect to the noise component extracted in the noise component extraction block 13, the pixel values of the noise components on the same line are arranged in the ascending/descending order in the unit of block, and the pixel value in a certain order is replaced with the pixel value within the same block and the pixel value in that order, whereby even in the image in which contrast is polarized between white and black, only the line-shaped noise can be effectively extracted.

Further, in the line-shaped noise component extraction block 14 in which the noise component generated in a line shape is extracted, with respect to the noise component extracted in the noise component extraction block 13, the pixel values of the noise components on the same line are arranged in the ascending/descending order in the unit of block, and a plurality of pixel values in a certain order are obtained. Further, the pixel value exceeding a certain threshold value is removed to calculate the average value of the pixel values of a plurality of images, and the pixel value is replaced with the average value in the unit of block, whereby only the line-shaped noise can be effectively extracted without smoothing the object contour information over the entire region of histogram.

In the line-shaped noise component subtraction block 15, a coefficient is multiplied by the line-shaped noise component image extracted in the line-shaped noise component extraction block 14, and the correction effect is restricted, whereby the influence of the pseudo image generated by the correction is reduced, and thus only the line-shaped noise component can be effectively removed.

Further, in the line-shaped noise component subtraction block 15, when the pixel value of the line-shaped noise component image extracted in the line-shaped noise component extraction block 14 exceeds a certain threshold value, the noise component is prevented from being further subtracted, whereby only the line-shaped noise component can be effectively removed without loosing the object contour information.

The present invention is not limited to the as-described embodiment. In an implementation stage, the components of the embodiment can be varied without departing from the spirit of the present invention. Furthermore, various inventions can be formed by appropriately combining a plurality of the components disclosed in the above-described embodiment. For example, some of the components shown in the embodiment may be deleted.

What is claimed is:

1. A radiation image processing device comprising:
a noise component extraction part which extracts a noise component from a radiation image;
a line-shaped noise component extraction part which extracts a line-shaped noise component from the noise component extracted by the noise component extraction part; and
a line-shaped noise component subtraction part which subtracts the line-shaped noise component, extracted by the line-shaped noise component extraction parts from the radiation image.

2. The radiation image processing device according to claim 1, wherein the noise component extraction part includes a smoothing part in which a smoothing filter is applied to each pixel of the radiation image and a smoothing component subtraction part which subtracts the pixel value of the pixel, smoothed by the smoothing part, from the pixel value of each pixel of the radiation image.

3. The radiation image processing device according to claim 2, wherein the smoothing part is a one-dimensional smoothing filter.

4. The radiation image processing device according to claim 2, wherein the smoothing part is a one-dimensional median filter.

5. The radiation image processing device according to claim 1, wherein the line-shaped noise component extraction part calculates, with respect to the image of the noise component extracted by the noise component extraction part, an average value of the noise components on the same line in the unit of block, and replaces the noise component within the same block with the average value, whereby the line-shaped noise component is extracted.

6. The radiation image processing device according to claim 1, wherein the line-shaped noise component extraction part calculates, with respect to the noise component extracted by the noise component extraction part, a median of the noise components on the same line in the unit of block, and replaces the noise component within the same block with the median, whereby the line-shaped noise component is extracted.

7. The radiation image processing device according to claim 1, wherein the line-shaped noise component extraction part arranges, with respect to the noise component extracted by the noise component extraction part, the pixel values of the noise components on the same line in a descending/ascending order in the unit of block, and replaces the pixel value in a certain order with the pixel value within the same block and the pixel value in that order, whereby the line-shaped noise component is extracted.

8. The radiation image processing device according to claim 1, wherein the line-shaped noise component extraction part arranges, with respect to the noise component extracted by the noise component extraction part, the pixel values of the noise components on the same line in a descending/ascending order in the unit of block, calculates a plurality of pixel values in a certain order, obtains, with respect to the respective pixel values in a certain order, an image in which the pixel value within the same block is replaced with the pixel value in that order, and removes a pixel value exceeding a certain threshold value to calculate the average value of the pixel values of a plurality of images, whereby the line-shaped noise component is extracted.

9. The radiation image processing device according to claim 1, wherein the line-shaped noise component subtraction part multiplies a coefficient by the line-shaped noise component image, extracted by the line-shaped noise component extraction part, to subtract the line-shaped noise component.

10. The radiation image processing device according to claim 1, wherein, when the pixel value of the line-shaped noise component image extracted by the line-shaped noise component extraction part exceeds a certain threshold value, the line-shaped noise component subtraction part replaces the pixel value with a certain threshold value.
